(19) United States
(12) Patent Application Publication
(10) Pub. No.: US 2025/0347769 A1
(43) Pub. Date: Nov. 13, 2025

(54) VEHICLE RADAR SYSTEM

(71) Applicant: Ford Global Technologies, LLC, Dearborn, MI (US)

(72) Inventors: Ashikur Rahman, Noblesville, IN (US); Siddharth Agarwal, Ann Arbor, MI (US); Ravikumar Chilmula, Troy, MI (US); Matthew Sherman, Hartland, MI (US); Stephen Giardinelli, Ypsilanti, MI (US)

(73) Assignee: Ford Global Technologies, LLC, Dearborn, MI (US)

(21) Appl. No.: 18/660,460

(22) Filed: May 10, 2024

(51) Int. Cl. G01S 7/35; G01S 13/00; G01S 13/931

(52) U.S. Cl. CPC G01S 7/35; G01S 13/003; G01S 13/931; G01S 2013/9322; G01S 2013/93271; G01S 2013/93272

(57) ABSTRACT

A radar system includes a first transmit antenna positioned to emit radar waves in an exterior direction relative to a vehicle to which the radar unit is mounted, a second transmit antenna positioned to emit radar waves into a passenger compartment of the vehicle, at least one first frequency multiplier positioned to increase a frequency of a signal from a wave generator to the first transmit antenna up to a first frequency, and at least one second frequency multiplier positioned to increase a frequency of the signal from the wave generator to the second transmit antenna up to a second frequency less than the first frequency.

### BACKGROUND

Modern vehicles can include radar. A radar transmits radio waves and receives reflections of those radio waves to detect physical objects in the environment. A radar can use direct propagation, i.e., measuring time delays between transmission and reception of radio waves, and/or indirect propagation, i.e., Frequency Modulated Continuous Wave (FMCW) method, i.e., measuring changes in frequency between transmitted and received radio waves.

### BRIEF DESCRIPTION OF THE DRAWINGS

FIG. 1 is a side diagrammatic view of an example vehicle with a radar unit.

FIG. 2 is a top diagrammatic view of another example vehicle with a radar unit.

FIG. 3 is a block diagram of the radar unit from FIG. 1.

FIG. 4A is a block diagram of a first example of the radar unit from FIG. 2.

FIG. 4B is a block diagram of a second example of the radar unit from FIG. 2.

FIG. 5 is a flowchart of an example process for using data from the radar unit.

### DETAILED DESCRIPTION

This disclosure describes a radar system for a vehicle. The radar system includes a first transmit antenna positioned to emit radar waves in an exterior direction relative to the vehicle to which the radar system is mounted, a second transmit antenna positioned to emit radar waves into a passenger compartment of the vehicle, at least one first frequency multiplier positioned to transmit a signal from a wave generator to the first transmit antenna, and at least one second frequency multiplier positioned to transmit the signal from the wave generator to the second transmit antenna. The at least one first frequency multiplier is configured to increase a frequency of the signal to a first frequency. The at least one second frequency multiplier is configured to increase the frequency of the signal to a second frequency. The second frequency is less than the first frequency. Beneficially, the radar system utilizes a single wave generator for both interior and exterior sensing. At the same time, the hardware components, e.g., the first and second frequency multipliers, configure the radar system to emit radar waves at different frequencies for interior versus exterior sensing. The first frequency is used for exterior sensing and can be tuned for detecting objects a distance from the vehicle. The second frequency is lower and is used for interior sensing. The second frequency can be tuned for detecting human occupants a shorter distance from the antenna.

A radar system includes a first transmit antenna positioned to emit radar waves in an exterior direction relative to a vehicle to which the radar unit is mounted, a second transmit antenna positioned to emit radar waves into a passenger compartment of the vehicle, at least one first frequency multiplier positioned to increase a frequency of a signal from a wave generator to the first transmit antenna up to a first frequency, and at least one second frequency multiplier positioned to increase a frequency of the signal from the wave generator to the second transmit antenna up to a second frequency less than the first frequency.

In an example, the wave generator may include a local oscillator configured to output a reference frequency.

In an example, the radar system may further include a frequency synthesizer positioned to receive the signal from the wave generator and output the signal to the at least one first frequency multiplier and to the at least one second frequency multiplier, the frequency synthesizer configured to increase a frequency of the signal.

In an example, the radar system may further include a first receive antenna positioned to receive reflected radar waves emitted by the first transmit antenna, and a first mixer positioned to receive from the first receive antenna and from the at least one first frequency multiplier. In a further example, the radar system may further include a second receive antenna positioned to receive reflected radar waves emitted by the second transmit antenna, and a second mixer positioned to receive from the second receive antenna and from the at least one second frequency multiplier.

In another further example, the radar system may further include a first analog-to-digital converter (ADC) positioned to receive a first intermediate frequency outputted by the first mixer. In a yet further example, the radar system may further include a second receive antenna positioned to receive reflected radar waves emitted by the second transmit antenna, a second mixer positioned to receive from the second receive antenna and from the at least one second frequency multiplier, and a second ADC positioned to receive a second intermediate frequency outputted by the second mixer.

In an example, the first frequency may be at least 76 GHz.

In an example, the second frequency may be at most 60 GHz.

In an example, the radar system may further include a circuit board to which the wave generator and the at least one first frequency multiplier are mounted. In a further example, the at least one second frequency multiplier may be mounted to the circuit board.

In another further example, the radar system may further include a cable connecting the second transmit antenna to the circuit board, the second transmit antenna being spaced from the circuit board. In a yet further example, the second frequency may be in a range of 1 to 5 GHz.

In an example, the first transmit antenna may be oriented to emit the radar waves in a vehicle-rearward direction relative to the vehicle.

In an example, the second transmit antenna may be oriented to emit the radar waves in a vehicle-forward direction relative to the vehicle.

In an example, the radar system may further include a radar unit including the wave generator, the first transmit antenna, the second transmit antenna, the at least one first frequency multiplier, and the at least one second frequency multiplier; and a computer communicatively coupled to the radar unit, the computer programmed to actuate a component of the vehicle based on data received from the radar unit. In a further example, the radar unit may further include a first receive antenna positioned to receive reflected radar waves emitted by the first transmit antenna, and a first analog-to-digital converter (ADC) positioned to receive output from the first receive antenna, and the computer may be communicatively coupled to the first ADC. In a yet further example, the computer may be programmed to determine a status of an object outside the vehicle, and to actuate the component based on the status of the object.

In another further example, the radar unit may further include a second receive antenna positioned to receive reflected radar waves emitted by the second transmit antenna, and a second analog-to-digital converter (ADC) positioned to receive output from the second receive antenna, and the computer may be communicatively coupled to the second ADC. In a yet further example, the computer may be programmed to determine a status of an occupant in the passenger compartment, and to actuate the component based on the status of the occupant.

With reference to the Figures, wherein like numerals indicate like parts throughout the several views, a radar system 105 includes a first transmit antenna 310 positioned to emit radar waves in an exterior direction relative to a vehicle 100 to which the radar system 105 is mounted, a second transmit antenna 320 positioned to emit radar waves into a passenger compartment 115 of the vehicle 100, at least one first frequency multiplier 330 positioned to transmit a signal from a wave generator 305 to the first transmit antenna 310, and at least one second frequency multiplier 335 positioned to transmit the signal from the wave generator 305 to the second transmit antenna 320. The at least one first frequency multiplier 330 is configured to increase a frequency of the signal to a first frequency. The at least one second frequency multiplier 335 is configured to increase the frequency of the signal to a second frequency. The second frequency is less than the first frequency.

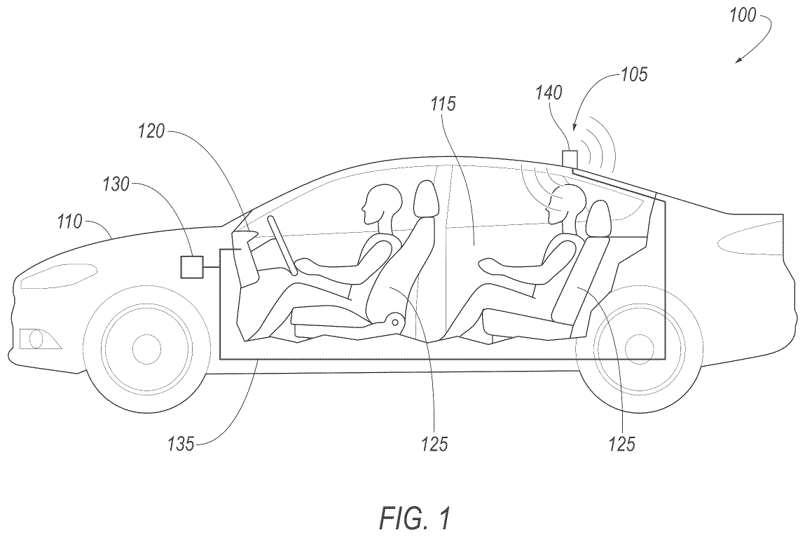

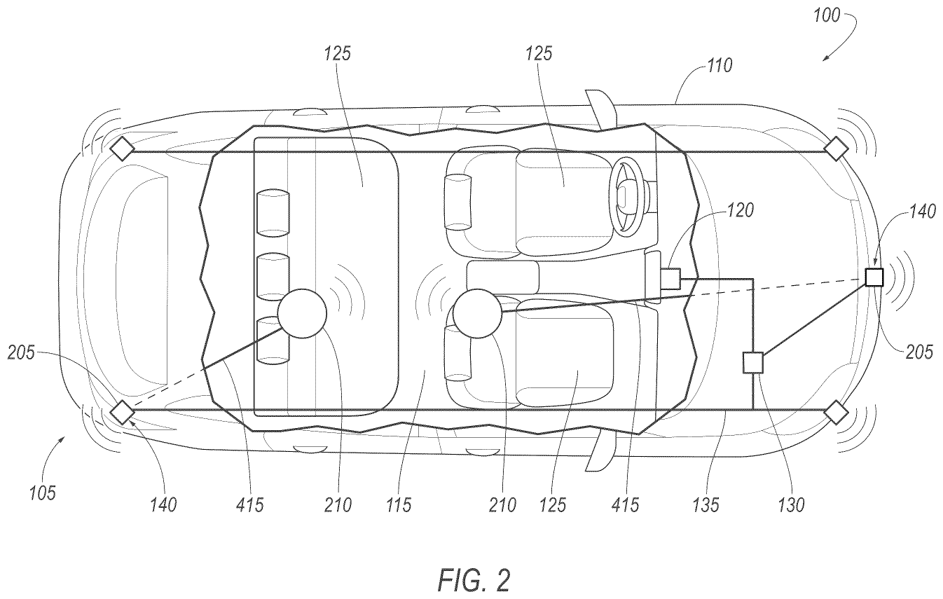

With reference to FIGS. 1-2, the vehicle 100 may be any passenger or commercial automobile such as a car, a truck, a sport utility vehicle, a crossover, a van, a minivan, a taxi, a bus, etc. The vehicle 100 includes a body 110, the passenger compartment 115, a user interface 120, and the radar system 105.

The vehicle 100 includes the body 110. The vehicle 100 may be of a unibody construction, in which a frame and the body 110 of the vehicle 100 are a single component. The vehicle 100 may, alternatively, be of a body-on-frame construction, in which the frame supports the body 110 that is a separate component from the frame. The frame and body 110 may be formed of any suitable material, for example, steel, aluminum, etc.

The vehicle 100 includes the passenger compartment 115 to house occupants, if any, of the vehicle 100. The passenger compartment 115 includes one or more of the seats 125 disposed in a front row of the passenger compartment 115 and one or more of the seats 125 disposed in a second row behind the front row. The passenger compartment 115 may also include seats 125 in a third row (not shown) at a rear of the passenger compartment 115. The seats 125 are shown to be bucket seats in the front row and bench seats in the second row, but the seats 125 may be other types. The position and orientation of the seats 125 and components thereof may be adjustable by an occupant.

The user interface 120 presents information to and receives information from an operator of the vehicle 100. The user interface 120 may be located, e.g., on an instrument panel in the passenger compartment 115, or wherever may be readily seen by the operator. The user interface 120 may include dials, digital readouts, screens, speakers, and so on for providing information to the operator, e.g., human-machine interface (HMI) elements such as are known. The user interface 120 may include buttons, knobs, keypads, microphone, and so on for receiving information from the operator.

The radar system 105 may include a computer 130, a communications network 135, and a radar unit 140.

The computer 130 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 130 can thus include a processor, a memory, etc. The memory of the computer 130 can include media for storing instructions executable by the processor as well as for electronically storing data and/or databases, and/or the computer 130 can include structures such as the foregoing by which programming is provided. The computer 130 can be multiple computers coupled together. The computer 130 may store programming for interacting with the radar unit 140 as described below as well as for interacting with other components of the vehicle 100.

The computer 130 may transmit and receive data through the communications network 135. The communications network 135 may be, e.g., a controller area network (CAN) bus, Ethernet, WiFi, Local Interconnect Network (LIN), onboard diagnostics connector (OBD-II), and/or any other wired or wireless communications network. The computer 130 may be communicatively coupled to the radar unit 140, the user interface 120, and other components via the communications network 135.

The radar unit 140 is positioned to detect objects outside the vehicle 100 and detect objects inside the vehicle 100, e.g., by emitting radar waves in an exterior direction relative to the vehicle 100, emitting radar waves into the passenger compartment 115, and receiving the reflected radar waves from the exterior direction and the passenger compartment 115. The radar unit 140 is fixedly mounted to the body 110 of the vehicle 100.

In the example of FIG. 1, the radar unit 140 is positioned on the body 110 at an upper edge of a rear window of the vehicle 100, e.g., adjacent to or as part of the center high-mounted stop lamp (CHMSL). The radar unit 140 emits radar waves in a vehicle-rearward direction exterior to the vehicle 100 and in a vehicle-forward direction into the passenger compartment 115.

In the example of FIG. 2, the radar unit 140 is split into a first subunit 205 positioned to emit radar waves in an exterior direction relative to the vehicle 100 and a second subunit 210 positioned to emit radar waves into the passenger compartment 115. The first subunit 205 may be positioned at an edge of a footprint of the vehicle 100, e.g., at a front or rear bumper of the body 110 of the vehicle 100. If positioned on the front bumper, the first subunit 205 emits radar waves in a vehicle-forward direction exterior to the vehicle 100. If positioned on the rear bumper, the first subunit 205 emits radar waves in a vehicle-rearward direction exterior to the vehicle 100. The second subunit 210 may be positioned in the passenger compartment 115, e.g., on an instrument panel or at the upper edge of the rear window. If positioned on the instrument panel, the second subunit 210 emits radar waves in a vehicle-rearward direction into the passenger compartment 115. If positioned at the rear of the passenger compartment 115 such as the upper edge of the rear window, the second subunit 210 emits radar waves in a vehicle-forward direction into the passenger compartment 115.

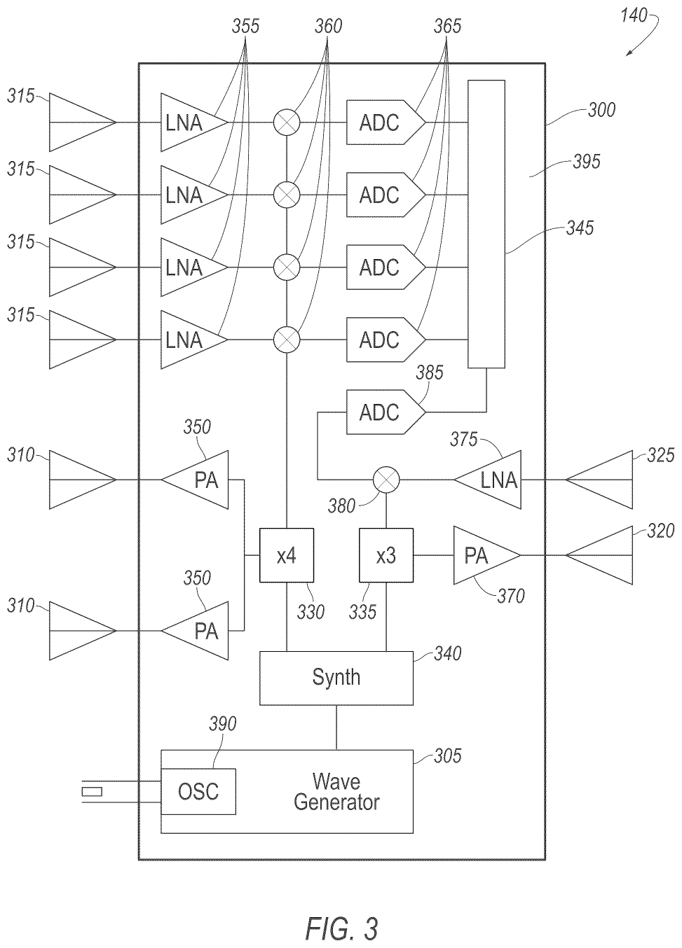

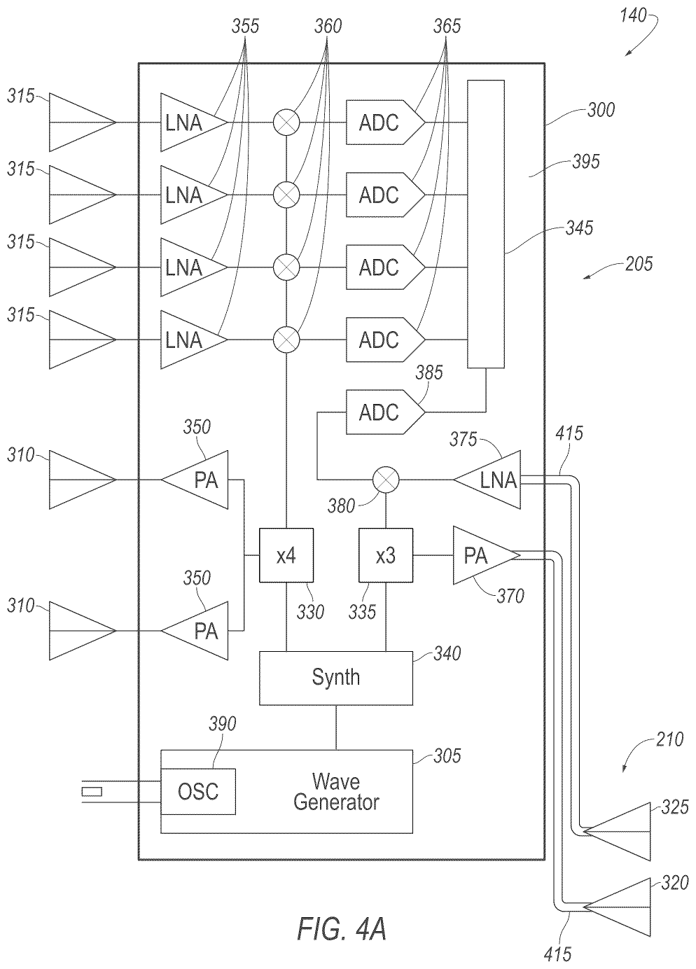

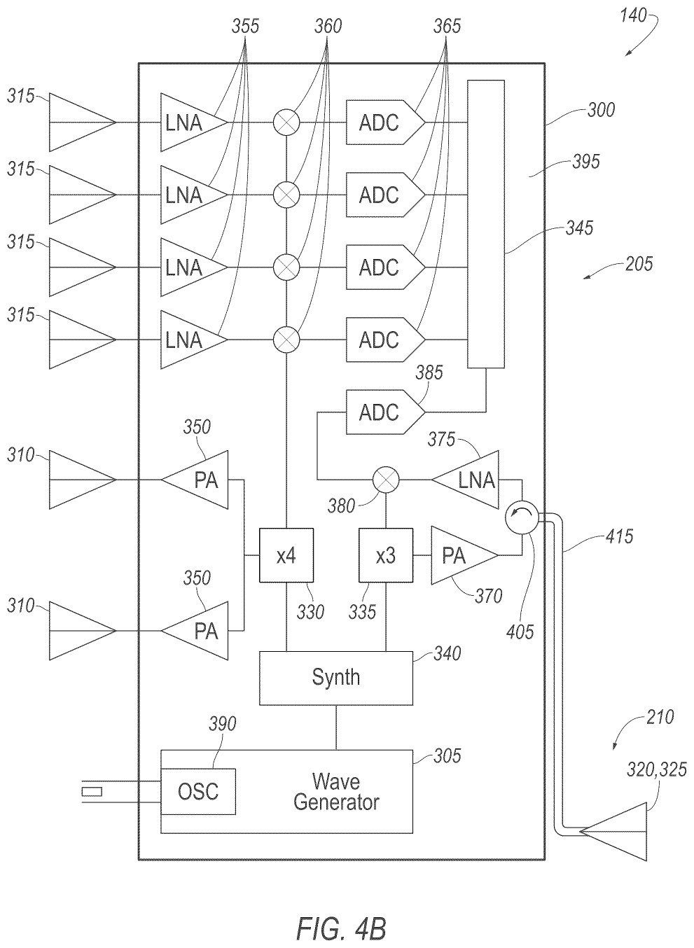

With reference to FIGS. 3-4B, the radar unit 140 includes the wave generator 305, a frequency synthesizer 340, and a digital front end 345. For detecting objects exterior to the vehicle 100, the radar unit 140 further includes the at least one first frequency multiplier 330, at least one first transmit amplifier 350, at least one first transmit antenna 310, at least one first receive antenna 315, at least one first receive amplifier 355, at least one first mixer 360, and at least one first analog-to-digital converter (ADC) 365. For detecting objects in the passenger compartment 115, the radar unit 140 further includes the at least one second frequency multiplier 335, at least one second transmit amplifier 370, at least one second transmit antenna 320, at least one second receive antenna 325, at least one second receive amplifier 375, at least one second mixer 380, and at least one second ADC 385.

As a general overview of detecting objects exterior to the vehicle 100, the wave generator 305 outputs a signal to the frequency synthesizer 340, which outputs the signal at a higher frequency to the at least one first frequency multiplier 330. The at least one first frequency multiplier 330 outputs the signal at a still higher frequency, referred to as the first frequency, to the first transmit amplifiers 350 and the first mixers 360. The first transmit amplifiers 350 provide the signal to the first transmit antennas 310, and the first transmit antennas 310 emit radar waves at the first frequency. The first receive antennas 315 receive the radar waves emitted by the first transmit antennas 310 that reflect off of the environment outside the vehicle 100. The first receive antennas 315 output to the first receive amplifiers 355, which in turn output to the first mixers 360. The first mixers 360 process the output from the first receive amplifiers 355 based on the signal from the at least one first frequency multiplier 330, resulting in a first intermediate frequency signal. The first ADCs 365 receive the first intermediate frequency signal and output to the digital front end 345.

As a general overview of detecting objects in the passenger compartment 115, the wave generator 305 outputs the signal to the frequency synthesizer 340, which outputs the signal at a higher frequency to the at least one second frequency multiplier 335. The at least one second frequency multiplier 335 outputs the signal at a still higher frequency, referred to as the second frequency, to the second transmit amplifiers 370 and the second mixers 380. The second transmit amplifiers 370 provide the signal to the second transmit antennas 320, and the second transmit antennas 320 emit radar waves at the second frequency. The second receive antennas 325 receive the radar waves emitted by the first transmit antennas 310 that reflect off of the objects in the passenger compartment 115. The second receive antennas 325 output to the second receive amplifiers 375, which in turn output to the second mixers 380. The second mixers 380 process the output from the second receive amplifiers 375 based on the signal from the at least one second frequency multiplier 335, resulting in a second intermediate frequency signal. The second ADCs 385 receive the second intermediate frequency signal and output to the digital front end 345.

The wave generator 305 is configured to output a signal. The wave generator 305 outputs an electrical signal with a periodic pattern. The signal therefore has a reference frequency, i.e., the number of times the pattern repeats per unit time. For example, the wave generator 305 may be a ramp generator. A ramp generator outputs a linear rising or falling signal with respect to time, resulting in a sawtooth waveform. The reference frequency may be chosen to be stable with a low power demand, e.g., 40 MHZ.

The wave generator 305 may include a local oscillator 390 configured to output the reference frequency. A local oscillator 390 is an electronic circuit that produces a periodic, oscillating, or alternating current (AC) signal, powered by a direct current (DC) source. The local oscillator 390 may be any suitable type, e.g., a crystal oscillator with a fixed reference frequency.

The frequency synthesizer 340 is positioned to receive the signal from the wave generator 305 and output the signal to the at least one first frequency multiplier 330 and to the at least one second frequency multiplier 335. The frequency synthesizer 340 is configured to increase a frequency of the signal. A frequency synthesizer is an electronic circuit that can generate a range of frequencies from a single reference frequency. The frequency synthesizer 340 may be any suitable type, e.g., a direct analog synthesizer, a direct digital synthesizer, indirect digital synthesizer, etc. The frequency synthesizer 340 may include one or more of frequency multiplication, frequency division, direct digital synthesis, frequency mixing, and phase-locked loops as part of the electronic circuit, as are known. The frequency synthesizer 340 may increase the frequency of the signal from the wave generator 305 by a factor of ten, e.g., from 40 MHz to 400 MHZ.

The at least one first frequency multiplier 330 is positioned to transmit the signal from the wave generator 305, e.g., received via the frequency synthesizer 340, to the first transmit antennas 310, e.g., via the first transmit amplifiers 350. The at least one first frequency multiplier 330 is configured to increase a frequency of the signal to the first frequency. A frequency multiplier is an electronic circuit that generates an output signal that is a harmonic, i.e., multiple, of an input frequency. For example, a frequency multiplier may include a nonlinear circuit that distorts the input signal to generate harmonics of the input signal, and a bandpass filter that removes the input frequency and the harmonics other than the desired output signal. For another example, a frequency multiplier may be a phase-locked loop, i.e., an electronic circuit that generates an output signal with a phase that is fixed relative to a phase of an input signal, combined with a frequency divider. The at least one first frequency multiplier 330 may include a single first frequency multiplier 330 or multiple first frequency multipliers 330 in series, i.e., the output of one first frequency multiplier 330 being the input of a next first frequency multiplier 330. For example, the at least one first frequency multiplier 330 may include two first frequency multipliers 330 in series, one that multiplies by a factor of 2 (e.g., from 400 MHz to 800 MHZ) and one that multiplies by a factor of 95 (e.g., from 800 MHz to 76 GHZ). The first frequency may be at least 76 GHZ, which can provide accurate range and velocity measurements while still penetrating certain adverse weather conditions.

The radar unit 140 may include one first transmit amplifier 350 for each first transmit antenna 310. An amplifier increases the amplitude of an input signal. Each first transmit amplifier 350 may increase the power of the signal received from the at least one first frequency multiplier 330 and output the higher-power signal to a respective one of the first transmit antennas 310. The first transmit amplifiers 350 preserve the frequency of the signal, i.e., maintain the frequency at the first frequency. In other words, the signal received by the first transmit antennas 310 has the same frequency as the signal outputted by the at least one first frequency multiplier 330. The first transmit amplifiers 350 may be any suitable type, e.g., power amplifiers.

The radar unit 140 includes one or more first transmit antennas 310. The first transmit antennas 310 emit radar waves based on the signal as received from the respective first transmit amplifiers 350, i.e., at the first frequency. The first transmit antennas 310 may be any suitable type for exterior short-range (up to 30 meters), medium-range (up to 60 meters), or long-range (up to 150 to 250 meters) detection, e.g., reflector and lens antennas, planar antennas such as microstrip antennas, etc. The first transmit antennas 310 are positioned to emit radar waves in an exterior direction relative to the vehicle 100, e.g., oriented to emit the radar waves in a vehicle-rearward direction relative to the vehicle 100, as described above with respect to the example of FIG. 1 and one of the locations in the example of FIG. 2.

The radar unit 140 includes one or more first receive antennas 315. The first receive antennas 315 detect reflected radar waves emitted by the first transmit antennas 310. The first receive antennas 315 are positioned to receive the reflected radar waves emitted by the first transmit antennas 310, e.g., are oriented in the same or a close direction as the first transmit antennas 310 are aimed. The first receive antennas 315 convert the detected radar waves to a carrier signal.

The radar unit 140 may include one first receive amplifier 355 for each first receive antenna 315. Each first receive amplifier 355 may increase the power of the carrier signal received from the respective first receive antenna 315 and output the higher-power carrier signal to a respective one of the first mixers 360. The first receive amplifiers 355 preserve the frequency of the carrier signal. The first receive amplifiers 355 may be any suitable type, e.g., low-noise amplifiers.

The radar unit 140 may include one first mixer 360 for each first receive antenna 315. Each first mixer 360 may be positioned to receive the carrier signal from a respective one of the first receive antennas 315, e.g., via a respective one of the first receive amplifiers 355, and may be positioned to receive a signal from the at least one first frequency multiplier 330, i.e., at the first frequency. Each first mixer 360 may mix the carrier signal and the signal from the at least one first frequency multiplier 330, e.g., with heterodyning, resulting in a signal at a first intermediate frequency. The first intermediate frequency may be the difference of the frequency of the carrier signal and the first frequency.

The radar unit 140 may include one first analog-to-digital converter (ADC) for each first antenna. Each first ADC 365 may be positioned to receive output from a respective one of the first receive antennas 315. For example, each first ADC 365 may be positioned to receive the first intermediate frequency signal outputted by the respective first mixer 360. Each first ADC 365 converts the first intermediate frequency signal to a digital signal. The first ADCs 365 output the digital signals to the digital front end 345.

The at least one second frequency multiplier 335 is positioned to transmit the signal from the wave generator 305, e.g., received via the frequency synthesizer 340, to the second transmit antennas 320, e.g., via the second transmit amplifiers 370. The at least one second frequency multiplier 335 is configured to increase a frequency of the signal to the second frequency. The at least one second frequency multiplier 335 may include a single second frequency multiplier 335 or multiple second frequency multipliers 335 in series, i.e., the output of one second frequency multiplier 335 being the input of a next second frequency multiplier 335. The second frequency may be at most 60 GHz, which can provide accurate range and velocity measurements in the passenger compartment 115 while still being suitable for use in close proximity to occupants. As one example, the second frequency may be approximately 60 GHz. For example, the at least one second frequency multiplier 335 may include one second frequency multiplier 335, which multiplies by a factor of 150 (e.g., from 400 MHz to 60 GHZ). As another example, the second frequency may be in the range of 1 to 5 GHZ, which can provide accurate range and velocity measurements in the passenger compartment 115, is suitable for use in close proximity to occupants, and has sufficiently low power requirements to facilitate placement of the second subunit 210 spaced from the wave generator 305 (as described below in the examples of FIGS. 4A-B). For example, the at least one second frequency multiplier 335 may include one second frequency multiplier 335, which multiplies by a factor of 6 (e.g., from 400 MHz to 2.4 GHZ).

The radar unit 140 may include one second transmit amplifier 370 for each second transmit antenna 320. Each second transmit amplifier 370 may increase the power of the signal received from the at least one second frequency multiplier 335 and output the higher-power signal to a respective one of the second transmit antennas 320. The second transmit amplifiers 370 preserve the frequency of the signal, i.e., maintain the frequency at the second frequency. In other words, the signal received by the second transmit antennas 320 has the same frequency as the signal outputted by the at least one second frequency multiplier 335. The second transmit amplifiers 370 may be any suitable type, e.g., power amplifiers.

The radar unit 140 includes one or more second transmit antennas 320. The second transmit antennas 320 emit radar waves based on the signal as received from the respective second transmit amplifiers 370, i.e., at the second frequency. The second transmit antennas 320 may be any suitable type for interior short-range detection, e.g., reflector and lens antennas, planar antennas such as microstrip antennas, etc. The second transmit antennas 320 are positioned to emit radar waves into the passenger compartment 115, e.g., oriented to emit the radar waves in a vehicle-forward direction relative to the vehicle 100, as described above with respect to the example of FIG. 1 and one of the locations in the example of FIG. 2.

The radar unit 140 includes one or more second receive antennas 325. The second receive antennas 325 detect reflected radar waves emitted by the second transmit antennas 320. The second receive antennas 325 are positioned to receive the reflected radar waves emitted by the second transmit antennas 320, e.g., are oriented in the same or a close direction as the second transmit antennas 320 are aimed. The second receive antennas 325 convert the detected radar waves to a carrier signal.

The radar unit 140 may include one second receive amplifier 375 for each second receive antenna 325. Each second receive amplifier 375 may increase the power of the carrier signal received from the respective second receive antenna 325 and output the higher-power carrier signal to a respective one of the second mixers 380. The second receive amplifiers 375 preserve the frequency of the carrier signal. The second receive amplifiers 375 may be any suitable type, e.g., power amplifiers (in the examples of FIGS. 4A-B) or low-noise amplifiers (in the example of FIG. 3).

The radar unit 140 may include one second mixer 380 for each second receive antenna 325. Each second mixer 380 may be positioned to receive the carrier signal from a respective one of the second receive antennas 325, e.g., via a respective one of the second receive amplifiers 375, and may be positioned to receive a signal from the at least one second frequency multiplier 335, i.e., at the second frequency. Each second mixer 380 may mix the carrier signal and the signal from the at least one second frequency multiplier 335, e.g., with heterodyning, resulting in a signal at a second intermediate frequency. The second intermediate frequency may be the difference of the frequency of the carrier signal and the second frequency.

The radar unit 140 may include one second ADC 385 for each second receive antenna 325. Each second ADC 385 may be positioned to receive output from a respective one of the second receive antennas 325. For example, each second ADC 385 may be positioned to receive the second intermediate frequency signal outputted by the respective second mixer 380. Each second ADC 385 converts the second intermediate frequency signal to a digital signal. The second ADCs 385 output the digital signals to the digital front end 345.

The digital front end 345 is positioned to receive the digital signals from the first ADCs 365 and the second ADCs 385. The digital front end 345 may process the digital signals to a format usable by the computer 130. The digital front end 345 is a communication interface to transmit the radar data generated by the radar unit 140 to other components of the vehicle 100, e.g., the computer 130, via the communications network 135. The digital front end 345 may include a processor and a memory.

The radar unit 140 may include a circuit board 395, e.g., a printed circuit board (PCB). The wave generator 305, the frequency synthesizer 340, the at least one first frequency multiplier 330, the first transmit amplifiers 350, the first receive amplifiers 355, the first mixers 360, and the first ADCs 365 may be mounted to the circuit board 395. Further, the at least one second frequency multiplier 335, the second transmit amplifiers 370, the second receive amplifiers 375, the second mixers 380, and the second ADCs 385 may be mounted to the circuit board 395. The circuit board 395, the attached components, and the digital front end 345 may be placed inside a housing 300. The first transmit antennas 310 and first receive antennas 315 may be mounted to the housing 300, and may be plugged directly into the first transmit amplifiers 350 and first receive amplifiers 355, respectively. The components mounted to the circuit board 395 and mounted to the housing 300 may thus serve as part of a single unit for placement in the vehicle 100.

With reference to FIG. 3, the second transmit antennas 320 and second receive antennas 325 may be mounted to the housing 300, and may be plugged directly into the second transmit amplifiers 370 and second receive amplifiers 375, respectively. In the example of FIG. 3, these additional components mounted to the housing 300 may thus serve as part of a single unit for placement in the vehicle 100. Because of the close proximity of the second transmit antennas 320 and second receive antennas 325 to the circuit board 395, the second frequency may be relatively high, e.g., 60 GHz as described above.

With reference to FIGS. 4A-B, the first subunit 205 includes the housing 300, the circuit board 395, the components mounted to the circuit board 395, the first transmit antennas 310, the first receive antennas 315, and the digital front end 345. The second subunit 210 includes the second transmit antennas 320 and the second receive antennas 325. The radar unit 140 further includes at least one cable 415 connecting the second transmit antennas 320 and second receive antennas 325 to the first subunit 205, e.g., to the second transmit amplifier 370 and second receive amplifier 375. For example, one cable 415 may connect the second transmit antenna 320 to the second transmit amplifier 370, and another cable 415 may connect the second receive antenna 325 to the second receive amplifier 375, as shown in FIG. 4A. For another example, the first subunit 205 may include a transmit/receive switch 405 connected to the second transmit amplifier 370 and second receive amplifier 375, and one cable 415 connects the transmit/receive switch 405 to a single antenna 320, 325 that serves as both the second transmit antenna 320 and as the second receive antenna 325, as shown in FIG. 4B. The transmit/receive switch 405 coordinates the transmissions of the signals through the single cable 415. The transmit/receive switch 405 may be any suitable type of three-port switch for rapidly switching the single antenna 320, 325 between acting as a transmitter and a receive, e.g., a circulator as shown in FIG. 4B, or a single-pole, double-throw switch, a PIN diode switch, a PIN-based T/R switch, etc. In the examples in both FIG. 4A and FIG. 4B, the second subunit 210, e.g., the second transmit antenna 320 and the second receive antenna 325, is spaced from the circuit board 395, as well as from the rest of the first subunit 205. This arrangement can provide placement of the first subunit 205 and second subunit 210 to detect different phenomena of interest while still being supplied by the same wave generator 305. The second frequency may be relatively low, e.g., in the range of 1 to 5 GHZ as described above, which facilitates the use of a lengthy cable 415 between spaced apart locations on the vehicle 100.

Returning to FIGS. 1-2, the computer 130 may be programmed to actuate a component of the vehicle 100 based on data received from the radar unit 140. As a general overview, the computer 130 may receive data from the radar unit 140, determine a status of an object outside the vehicle 100 or occupant in the passenger compartment 115, and actuate the component based on the status. For example, the computer 130 may actuate the component based on the status by determining whether the status satisfies a condition and actuating the component in response to the condition being satisfied.

The computer 130 is communicatively coupled to the radar unit 140 via the communications network 135. Specifically, the computer 130 is communicatively coupled to the first ADC 365 and the second ADC 385 and receives data from the first ADC 365 and second ADC 385 via the digital front end 345 and the communications network 135.

The computer 130 may be programmed to determine a status of an object outside the vehicle 100 based on the data from the first ADCs 365. For example, the status may include a distance and direction from the vehicle 100 to the object. The computer 130 may be programmed to determine a status of an occupant in the passenger compartment 115 based on the data from the second ADCs 385. For example, for each seat 125, the status may be that an occupant is present or absent.

The computer 130 may be programmed to determine whether the status of the object or occupant satisfies a condition. For example, the condition may include that the object is less than a threshold distance from the body 110 of the vehicle 100. The condition may include other requirements in addition to the status, e.g., that the speed of the vehicle 100 is below a threshold speed. The threshold distance and threshold speed may be chosen to provide sufficient time before the vehicle 100 contacts the object in a particular scenario, e.g., as part of a parking assistance feature. For another example, the condition may include that an occupant is in a specific seat 125 of the passenger compartment 115, e.g., a rear seat 125. The condition may include other requirements in addition to the status, e.g., that the vehicle 100 has just been turned off and/or that a front door is open.

The computer 130 may be programmed to actuate a component of the vehicle 100 based on the status of the object or occupant, e.g., in response to the condition being satisfied. For example, the computer 130 may actuate the user interface 120 to inform an operator of the vehicle 100 that the condition is satisfied. As one example, the computer 130 may instruct the user interface 120 to display a message or graphic indicating the distance and/or heading to the object outside the vehicle 100 and emit a beep or other sound, e.g., at a frequency that increases as the distance to the object decreases. As another example, the computer 130 may instruct the user interface 120 to display a message or graphic and emit a beep or other sound in response to an occupant being in a rear seat 125 after the vehicle 100 has turned off and a front door has opened.

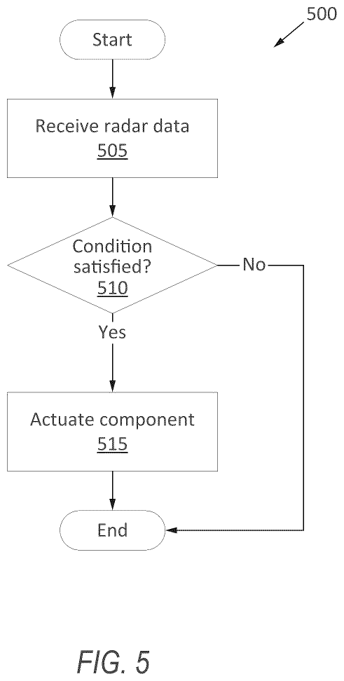

FIG. 5 is a flowchart illustrating an example process 500 for the radar system 105 to use data from the radar unit 140. The memory of the computer 130 stores executable instructions for performing the steps of the process 500 and/or programming can be implemented in structures such as mentioned above. As a general overview of the process 500, the computer 130 receives data from the radar unit 140 and actuates a component of the vehicle 100 in response to a condition being satisfied. The process 500 may continue repeatedly while the vehicle 100 is on.

The process 500 begins in a block 505, in which the computer 130 receives data from the radar unit 140, as described above.

Next, in a decision block 510, the computer 130 determines whether a status of an object outside the vehicle 100 or an occupant of the passenger compartment 115 satisfies a condition, as described above. In response to the condition being satisfied, the process 500 proceeds to a block 515. In response to the condition not being satisfied, the process 500 ends.

In the block 515, the computer 130 actuates the component based on the status of the object or occupant, e.g., according to the condition that was satisfied, as described above. After the block 515, the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A radar system comprising:
a first transmit antenna positioned to emit radar waves in an exterior direction relative to a vehicle to which the radar system is mounted;
a second transmit antenna positioned to emit radar waves into a passenger compartment of the vehicle;
at least one first frequency multiplier positioned to transmit a signal from a wave generator to the first transmit antenna, the at least one first frequency multiplier configured to increase a frequency of the signal to a first frequency; and
at least one second frequency multiplier positioned to transmit the signal from the wave generator to the second transmit antenna, the at least one second frequency multiplier configured to increase the frequency of the signal to a second frequency, the second frequency being less than the first frequency.

2. The radar system of claim 1, wherein the wave generator includes a local oscillator configured to output a reference frequency.

3. The radar system of claim 1, further comprising a frequency synthesizer positioned to receive the signal from the wave generator and output the signal to the at least one first frequency multiplier and to the at least one second frequency multiplier, the frequency synthesizer configured to increase a frequency of the signal.

4. The radar system of claim 1, further comprising a first receive antenna positioned to receive reflected radar waves emitted by the first transmit antenna, and a first mixer positioned to receive from the first receive antenna and from the at least one first frequency multiplier.

5. The radar system of claim 4, further comprising a second receive antenna positioned to receive reflected radar waves emitted by the second transmit antenna, and a second mixer positioned to receive from the second receive antenna and from the at least one second frequency multiplier.

6. The radar system of claim 4, further comprising a first analog-to-digital converter (ADC) positioned to receive a first intermediate frequency outputted by the first mixer.

7. The radar system of claim 6, further comprising a second receive antenna positioned to receive reflected radar waves emitted by the second transmit antenna, a second mixer positioned to receive from the second receive antenna and from the at least one second frequency multiplier, and a second ADC positioned to receive a second intermediate frequency outputted by the second mixer.

8. The radar system of claim 1, wherein the first frequency is at least 76 GHz.

9. The radar system of claim 1, wherein the second frequency is at most 60 GHz.

10. The radar system of claim 1, further comprising a circuit board to which the wave generator and the at least one first frequency multiplier are mounted.

11. The radar system of claim 10, wherein the at least one second frequency multiplier is mounted to the circuit board.

12. The radar system of claim 10, further comprising a cable connecting the second transmit antenna to the circuit board, the second transmit antenna being spaced from the circuit board.

13. The radar system of claim 12, wherein the second frequency is in a range of 1 to 5 GHz.

14. The radar system of claim 1, wherein the first transmit antenna is oriented to emit the radar waves in a vehicle-rearward direction relative to the vehicle.

15. The radar system of claim 1, wherein the second transmit antenna is oriented to emit the radar waves in a vehicle-forward direction relative to the vehicle.

16. The radar system of claim 1, further comprising:
a radar unit including the wave generator, the first transmit antenna, the second transmit antenna, the at least one first frequency multiplier, and the at least one second frequency multiplier; and
a computer communicatively coupled to the radar unit, the computer programmed to actuate a component of the vehicle based on data received from the radar unit.

17. The radar system of claim 16, wherein the radar unit further includes a first receive antenna positioned to receive reflected radar waves emitted by the first transmit antenna, and a first analog-to-digital converter (ADC) positioned to receive output from the first receive antenna, and the computer is communicatively coupled to the first ADC.

18. The radar system of claim 17, wherein the computer is programmed to determine a status of an object outside the vehicle, and to actuate the component based on the status of the object.

19. The radar system of claim 16, wherein the radar unit further includes a second receive antenna positioned to receive reflected radar waves emitted by the second transmit antenna, and a second analog-to-digital converter (ADC) positioned to receive output from the second receive antenna, and the computer is communicatively coupled to the second ADC.

20. The radar system of claim 19, wherein the computer is programmed to determine a status of an occupant in the passenger compartment, and to actuate the component based on the status of the occupant.
